(19) United States
(12) Patent Application Publication
(10) Pub. No.: US 2011/0132187 A1
(43) Pub. Date: Jun. 9, 2011

(54) HYDRAULIC STORED-ENERGY SPRING MECHANISM

(75) Inventor: Henrik LOHRBERG, Frankfurt (DE)

(73) Assignee: ABB Technology AG, Zurich (CH)

(21) Appl. No.: 12/986,542

(22) Filed: Jan. 7, 2011

Related U.S. Application Data
(63) Continuation of application No. PCT/EP2009/004778, filed on Jul. 2, 2009.

(30) Foreign Application Priority Data
Jul. 8, 2008 (DE) 10 2008 032 143.5

(51) Int. Cl. F16J 1/10

(52) U.S. Cl. 92/84

(57) ABSTRACT

Exemplary embodiments are directed to a hydraulic stored-energy spring mechanism for a high voltage circuit breaker. The spring mechanism includes a working cylinder situated in a working cylinder housing, at least one spring and at least one compression piston. The compression piston is slidably displaceable in a storage cylinder. The at least one storage spring pressurizes fluid located in the storage piston via the compression piston. The storage spring is held in a form-fitting manner by a support tube unit in the preloaded state.

### RELATED APPLICATION

This application claims priority as a continuation application under 35 U.S.C. §120 to PCT/EP2009/004778, which was filed as an International Application on Jul. 2, 2009 designating the U.S., and which claims priority to German Application 102008032143.5 filed in Germany on Jul. 8, 2008. The entire contents of these applications are hereby incorporated by reference in their entireties.

### FIELD

The disclosure relates to a spring mechanism, such as a hydraulic stored-energy spring mechanism for a high-voltage circuit breaker.

### BACKGROUND INFORMATION

Patent application EP 0829892 describes a stored-energy spring mechanism used in a high-voltage circuit breaker. Via a compression body and a compression piston, which is displaceable by sliding in a storage cylinder, a storage spring places a fluid located in the storage cylinder under pressure. Using this fluid, a drive rod fastened on a drive piston, which is displaceable by sliding in a working cylinder is moved. If the working piston is moved using the working rod into a first end position, via the working rod, the working piston closes the circuit breaker. If the working piston is moved using the working rod into a second end position, the working piston opens the circuit breaker.

If when under high pressure, the fluid is conducted into an area of the working cylinder facing away from the working rod, the working piston is moved into the first end position. If when under low pressure, the fluid is conducted into area of the working cylinder, the working piston is moved into the second end position.

The hydraulic system is unpressurized during installation of the stored-energy spring mechanism and during maintenance work. The storage spring is only preloaded in this state and stretches out maximally. The storage spring presses the compression body against a stop on the working cylinder housing, whereby the compression body is clamped between the stop and the storage spring.

The hydraulic system is under pressure during the operation of the stored-energy spring mechanism. The storage spring is tensioned further in this state, which is also referred to as loaded hereafter, and its axial stretching is reduced. The storage spring presses the compression body against the compression piston, which thus places the fluid under pressure.

On the opposite side, the storage spring is supported on a support, which is fastened on the housing of the working cylinder.

When the hydraulic system is unpressurized, i.e., when the storage spring is preloaded, the storage spring is supported on the compression body, which in turn presses on the stop of the working cylinder housing.

The storage spring is thus connected in a form-fitting manner to the working cylinder housing. To remove the storage spring from the working cylinder housing, for example, because of maintenance work on the mechanism, a spring press can be specified. With the aid of the spring press, the storage spring is first compressed, subsequently the support ring is removed, and then the storage spring is pulled out of the working cylinder housing.

The installation of the storage spring on the working cylinder housing after completion of the maintenance work and during the manufacturing of the mechanism is also complex.

### SUMMARY

An exemplary embodiment is directed to a hydraulic stored-energy spring mechanism for a high voltage circuit breaker. The spring mechanism includes a working cylinder situated in a working cylinder housing, at least one spring and at least one compression piston. The compression piston is slidably displaceable in a storage cylinder. The at least one storage spring pressurizes fluid located in the storage piston via the compression piston. The storage spring is held in a form-fitting manner by a support tube unit in the preloaded state.

### BRIEF DESCRIPTION OF THE DRAWINGS

The disclosure, advantages and improvements of the exemplary embodiments are explained and described in greater detail on the basis of the drawing, in which an exemplary embodiment of the disclosure is shown.

FIG. 1 illustrates a hydraulic stored-energy spring mechanism according to an exemplary embodiment of the present disclosure.

### DETAILED DESCRIPTION

The object of an exemplary embodiment of the present disclosure is to refine a hydraulic stored-energy spring mechanism of a high-voltage circuit breaker at the beginning in such a manner that the storage spring can be installed and removed with comparatively little effort.

A hydraulic stored-energy spring mechanism according to the present disclosure for a high-voltage circuit breaker includes, in addition to a working cylinder in a working cylinder housing, a storage spring, and a compression piston situated in a storage cylinder, and a support tube unit, which is fastened on the working cylinder housing and which is designed in such a manner that the storage spring is held in a form-fitting manner by the support tube unit in the preloaded state.

As a result, in the preloaded state, the storage spring thus does not exert force on the working cylinder housing, but rather only on the support tube unit.

The support tube unit and the storage spring are parts of a separate assembly, which is also referred to hereafter as a spring column.

The removal of the storage spring from the working cylinder housing is thus advantageously simplified in that the entire spring column is simply detached as a unit from the working cylinder housing for this purpose, which is possible without the use of a spring press. Correspondingly, during the installation of the storage spring, the entire spring column is fastened on the working cylinder housing.

The spring column is fastened on the working cylinder housing such that, during the operation of the stored-energy spring mechanism, when the hydraulic system is under pressure, the storage spring presses against the compression piston, or against the compression body. The spring column can be fastened on the working cylinder housing by a screw connection. A screw connection permits the spring column to be installed and removed with comparatively little effort.

Furthermore, it is advantageous that a spring column having a preloaded storage spring is producible as a separate, complete, superior, and pretested assembly. The manufacturing of a mechanism without spring press is also made possible in this way and thus significantly simplified. Such a spring column can be provided by a subcontractor, for example. The installation and the testing of the characteristic curve of the storage spring can be performed by the subcontractor in one work step. The setting of the storage spring, which typically lasts over 32 hours and is performed on a fully installed mechanism, can also be performed by the subcontractor on the spring column. The cycle time for manufacturing a mechanism can further be reduced.

The construction of a spring column proves to be comparatively space-saving if the support tube unit comprises a support tube, the storage spring being situated coaxially around the support tube.

The construction of the spring column can be implemented compactly in that a shoulder protruding radially outward can be molded or installed on a frontal end of the support tube, wherein the storage spring is supported on the shoulder.

The production of a spring column can be simplified in that a support ring is fastened coaxially around the support tube in proximity to a frontal end of the support tube. The storage spring is supported on the support ring. During the production, firstly the storage spring is pushed over the support tube and tensioned with the aid of a spring press and then is fastened.

The construction of the stored-energy spring mechanism can be space-saving if the central axes of the support tube unit and the working cylinder housing align with one another.

Further space savings can result if the support tube unit at least partially coaxially encloses the working cylinder housing.

According to another exemplary embodiment of the present disclosure, the storage cylinder in which the compression piston and the fluid are located can be in a container body, integrally formed with the working cylinder housing.

The storage cylinder and the working cylinder can be connected via a duct system, so that the fluid can flow out of the storage cylinder into the working cylinder and can apply a force thereto.

By combining the container body and the working cylinder housing into one component, which is referred to hereafter as a cylinder block, the outlay for the manufacturing of the stored-energy spring mechanism is reduced. Installation of the container body on the working cylinder housing thereby becomes superfluous. Furthermore, seals in the duct system in which the fluid flows from the storage cylinder into the working cylinder can be dispensed. The outlay for the disposition and warehousing are thus also reduced, since the spectrum of parts is reduced.

The stored-energy spring mechanism includes a working cylinder 40, which is situated inside a working cylinder housing 12. Furthermore, the stored-energy spring mechanism includes a container body 30, in which a storage cylinder 32 is situated. A compression piston 34 can be situated to be displaceable by sliding inside the storage cylinder 32.

A support tube 20, such as a hollow cylinder, can be fastened on the working cylinder housing 12. A shoulder 26, which protrudes radially outward, can be molded or installed on a frontal end of the support tube 20. A support ring 22 can be attached in proximity to the opposite frontal end of the support tube 20.

The support tube 20 can be fixedly screwed onto the working cylinder housing 12 using a screw connection (not shown). It should be apparent that other types of fastening can be used as desired.

A preloaded storage spring 10, such as a disc spring, can be situated coaxially around the support tube 20. The storage spring 10 can be supported at one end on the shoulder 26 and at the other end on the support ring 22.

The storage spring 10 can be implemented as a coiled spring, for example. In a typical stored-energy spring mechanism for a high-voltage circuit breaker, the storage spring 10 can be preloaded using a force of approximately 300 kN. In operation, the tension force of the loaded storage spring 10 increases up to 700 kN and possibly more.

The support tube 20 having the shoulder 26 and the support ring 22 are parts of a support tube unit which holds the storage spring 10 in a form-fitting manner in the preloaded state. The support tube unit and the storage spring 10 form a spring column. In the preloaded state of the storage spring 10, the force flow is closed by the storage spring 10, the support ring 22, the support tube 20, and the shoulder 26. In other words, the force flow is closed within the spring column when the storage spring 10 is preloaded.

The support tube unit and also the spring column can be implemented as a hollow cylinder. The central axes of the support tube 20, the support tube unit, and the spring column can be coextensive as provided in the example shown. An eccentric configuration of the working cylinder in relation to the support tube unit is also conceivable.

The support tube 20 is fastened on the working cylinder housing 12 in such that the shoulder 26 faces toward the container body 30 having the storage cylinder 32 and the compression piston 34. The shoulder 26 presses against a stop 24 of the working cylinder housing 12. The central axis of the support tube 20, which is coextensive with the central axes of the support tube unit and the spring column, can be aligned with the central axis of the working cylinder housing 12.

The support tube 20 and therefore also the support tube unit and the spring column partially and coaxially enclose the working cylinder housing 12. The working cylinder housing 12 thus lies partially within the support tube 20.

A support spring 28 is provided on the end of the storage spring 10 which faces toward the shoulder 26. The support spring 28 is part of the storage spring 10 and is rigid, i.e., the support spring 28 is minimally deformed or not at all during the tensioning and during the relaxation of the storage spring 10.

The stored-energy spring mechanism further includes a compression body 16, which can be situated between the storage spring 10 and the compression piston 34. When the storage spring 10 is tensioned, the support spring 28 presses on the compression body 16, which presses on the compression piston 34 and thus places the fluid located in the storage cylinder 32 under pressure. When the storage spring 10 is preloaded and the hydraulic system is unpressurized, the support spring 28 presses against the shoulder 26 of the support tube 20. The compression body 16 can be mounted without force or nearly without force between the support spring 28 and the compression piston 34 in this case.

In an exemplary embodiment, the compression body 16 can also be situated such that it is clamped between the support spring 28 and the shoulder 26 of the support tube 20 when the storage spring 10 is preloaded. As a result, the compression body 16 is also a part of the support tube unit and/or the spring column.

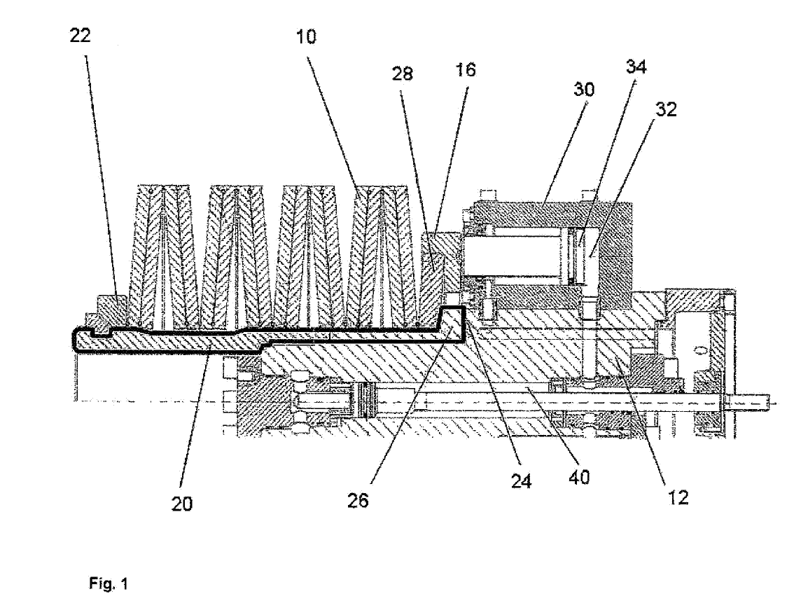

As shown in FIG. 1, the working cylinder housing 12 and the container body 30 can be formed as separate components which are connected to one another. In an exemplary embodiment, the working cylinder housing 12 and the container body 30 can be integrally formed, for example, as a cast part. In this case, the working cylinder housing 12 and the container body 30 can form a cylinder block. The exemplary cast part advantageously has an outer contour of the cylinder block that can be fixed during the casting procedure, whereby the machining effort during the manufacturing of the cylinder block is reduced.

The cylinder block can advantageously be produced from cast iron. As a result, the surface treatment of the running surfaces, which is also referred to as anodization, can be omitted. Based on the above techniques and materials, the service life of the stored-energy spring mechanism can be increased.

To reduce lateral forces which may occur due to radial movements of the storage spring 10 and in particular the support spring 28, a guide ring (not shown) can be provided. This guide ring, which is then also part of the spring column and/or the support tube unit, can be situated coaxially around the support tube 20 such that the pretensioned storage spring 10 presses the guide ring against the shoulder 26 of the support tube 20.

The guide ring can be mounted to slide on the support tube in the axial direction and moves away from the shoulder 26 during tensioning of the storage spring 10. As a result, radial movement of the guide ring is not possible.

When the storage spring 10 is tensioned, the guide ring can be situated adjacent to the compression body 16 without any radial play, so that a radial movement of the compression body is also prevented.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE NUMERALS

10 storage spring

12 working cylinder housing

16 compression body

20 support tube

22 support ring

24 stop

26 shoulder

28 support spring

30 container body

32 storage cylinder

34 compression piston

40 working cylinder

What is claimed is:

1. A hydraulic stored-energy spring mechanism for a high-voltage circuit breaker, comprising:
a working cylinder situated in a working cylinder housing;
at least one storage spring, at least one compression piston is displaceable by sliding in a storage cylinder wherein the at least one storage spring pressurizes fluid located in the storage piston via the compression piston, and
wherein the storage spring is held in a form-fitting manner by a support tube unit in the preloaded state.

2. The hydraulic stored-energy spring mechanism of claim 1, wherein the support tube unit comprises a support tube, and wherein the storage is being situated coaxially around the support tube.

3. The hydraulic stored-energy spring mechanism of claim 2, wherein a shoulder that protrudes radially outward is molded onto a frontal end of the support tube, and
wherein the storage spring is supported on the shoulder.

4. The hydraulic stored-energy spring mechanism according to claim 2, wherein a support ring is fastened coaxially around the support tube in proximity to a frontal end of the support tube, and
wherein the storage spring is supported on the support ring.

5. The hydraulic stored-energy spring mechanism according to claim 1, wherein the central axes of the support tube unit and the working cylinder housing are aligned.

6. The hydraulic stored-energy spring mechanism of claim 5, wherein the support tube unit at least partially coaxially encloses the working cylinder housing.

7. The hydraulic stored-energy spring mechanism of claim 1, wherein the storage cylinder is situated in a container body, integrally formed with the working cylinder housing.
